(19) United States
(12) Patent Application Publication
(10) Pub. No.: US 2006/0215042 A1
(43) Pub. Date: Sep. 28, 2006

(54) Image processing method and apparatus with provision of status information to a user

(75) Inventors: Sek M. Chai, Streamwood, IL (US); Mohamed I. Ahmed, Glendale Heights, IL (US); Bei Tang, Hoffman Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 11/088,498

(22) Filed: Mar. 24, 2005

(51) Int. Cl. H04N 5/225

(52) U.S. Cl. 348/222.1

(57) ABSTRACT

As input image data is received (101) and processed (102) using an image processing process (103) comprised of a plurality of discrete image processing steps, image processing content as corresponds to one or more intermediate discrete image processing steps is evaluated (104) using corresponding evaluation criteria. Corresponding discrete image processing status information is then provided (105).

### TECHNICAL FIELD

This invention relates generally to the digital processing of images and more particularly to providing information to a user regarding such processing.

### BACKGROUND

The digital processing of captured images comprises a relatively well known and growing field of endeavor and activity. Images captured through various means (via, for example, digital cameras, scanning, or the like) are processed to support various purposes including but not limited to recordation, artistic presentation, content analysis and/or interpretation, human-machine interfacing, and so forth. Depending upon the needs of the application, such digital processing can include, but is certainly not limited to image segmentation, image filtering, image detection, image tracking, image modeling, image classification, and image recognition, to name but a few.

In many cases, a user of such a process typically receives little by way of feedback aside from viewing the end processed result. For some purposes this can be adequate. In other settings, however, this can lead to problems, including but not limited to lower user satisfaction. For example, in some applications an image of a user will be captured and then processed to effect some purpose (as one simple example, some aspect of a user's face may be analyzed as part of a recognition-based controlled-access mechanism). When the captured image is inadequate to support appropriate processing, the intended purpose will often not be realized. Aside from observing the absence of the intended purpose, however, the user may be otherwise ignorant as to how or why the captured image was inadequate.

A captured image can be inadequate to support a given process for any of a wide variety of reasons. Some examples include, but are not limited to, insufficient (or too much) lighting, undue intermingling of foreground and background imagery, an absence of critical content within a field of view and/or a field of depth of the image capture apparatus, undue (or insufficient) movement of an object during the image capture process, and so forth. A lack of information regarding a particular cause of image capture inadequacy, however, can lead to delayed and/or denied effectuation of the corresponding image processing-based task. This can occur at least in part due to a delayed and/or an inappropriate attempt on the part of the user to remedy the condition that led to the inadequacy.

### BRIEF DESCRIPTION OF THE DRAWINGS

The above needs are at least partially met through provision of the image processing method and apparatus with provision of status information to a user described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a block diagram as configured in accordance with various embodiments of the invention;

FIG. 5 comprises an illustrative informational icon as configured in accordance with various embodiments of the invention;

FIG. 6 comprises an illustrative informational icon as configured in accordance with various embodiments of the invention;

FIG. 7 comprises an illustrative informational icon as configured in accordance with various embodiments of the invention;

FIG. 8 comprises an illustrative informational icon as configured in accordance with various embodiments of the invention;

FIG. 9 comprises an illustrative informational icon as configured in accordance with various embodiments of the invention;

FIG. 10 comprises an illustrative informational icon as configured in accordance with various embodiments of the invention; and

FIG. 11 comprises illustrative informational icons as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an input image is received as corresponds to an image processing process that is comprised of a plurality of discrete image processing steps. The image processing process is used to process the input image and resultant image processing content is evaluated as corresponds to at least one of the plurality of discrete image processing steps with respect to at least one evaluation criteria to provide a corresponding evaluation result. Discrete image processing status information is then provided to a user as corresponds to the evaluation result.

Depending upon the needs of a given application, the discrete image processing status information can be selected from amongst a plurality of candidates as a function, for example, of the relative importance of the discrete image processing step as corresponds to the evaluation result, information regarding the relative experience of the user (as pertains to the image processing process, for example), or the like. In a preferred approach, such evaluation occurs during the processing of the input image such that the discrete image processing status information can be provided to the user, at least in some cases, prior to the conclusion of the image processing process. The discrete image processing status information itself can take various forms with representative graphic icons being a vehicle of choice for many application settings.

So configured, a user (including even a relatively inexperienced user) can receive useful feedback, often during the image processing process itself, that can be employed by the user to improve the conduct of the image processing process and/or the likelihood of successfully achieving a desired corresponding image processing-based result or function. For example, a user may now know to rearrange themselves in a specific way in order to achieve their sought after result.

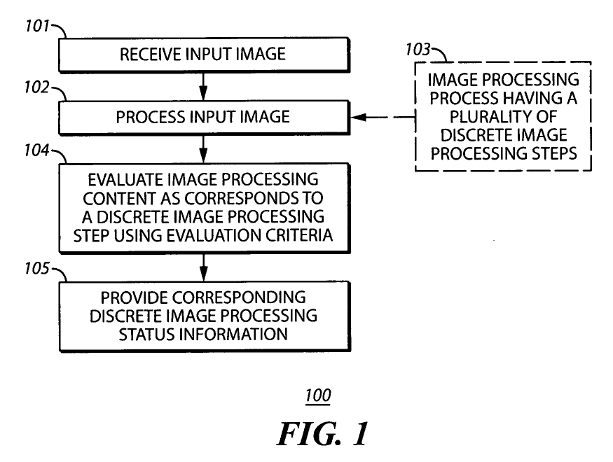

These and other benefits may become clearer upon making a thorough review and study of the following detailed description. Referring now to the drawings, and in particular to FIG. 1, a corresponding process 100 provides for receipt 101 on an input image. This input image will typically comprise a digital representation of an original object, setting, or location. Various formats (including, for example, tagged image file format (TIFF), joint photographic experts group (JPEG) format, and basic multilingual plane (BMP) format, to name but a few) are known in the art and others will no doubt be promulgated in the future. As such formats are well understood in the art, and as these teachings are generally applicable without preference for any particular format, for the sake of brevity no further elaboration regarding such formats will be provided here.

This process 100 then provides for processing 102 of the input image using, for example, an image processing process 103 that is comprised of a plurality of discrete image processing steps. Such image processing processes are generally known and understood in the art as are their constituent image processing steps (wherein the latter can comprise, for example, such steps as image filtering processing steps, image segmentation processing steps, image detection processing steps, image tracking processing steps, image modeling processing steps, image classification processing steps, and/or image recognition processing steps, to name but a few). As with image formats, such discrete image processing steps are known in the art. As these teachings are generally applicable with a wide variety and combination of existing and/or hereafter-developed steps, no further elaboration will be provided here for the sake of brevity and the preservation of narrative focus.

This process 100 then provides for evaluating 104 resultant image processing content as corresponds to one or more of the plurality of discrete image processing steps. In a preferred approach, this evaluation occurs with respect to at least one evaluation criteria. In a preferred approach this evaluation criteria corresponds to a measure of processing acceptability as relates, at least in part, to a condition as regards the input image. The condition (or conditions) of interest can and will vary with the needs of a given application. Examples of potentially useful conditions include, but are not limited to:
image brightness;
image exposure;
image focus;
image white balance;
image frame rate;
a position of at least a portion of the image;
illumination of at least a portion of the image;
juxtapositioning of at least two portions of the image (such as, for example, a foreground component of the image with respect to a background component of the image);
substantive image content;
movement of an element of the image;
temporal persistence of at least a portion of the image; and
ambiguity with respect to substantive content of the image; to name a few.

For some applications, there may be only one potentially appropriate evaluation criteria to use with respect to a given process and/or a given discrete image processing step. In other cases, it may be appropriate to provide a plurality of candidate evaluation criteria. In such a case, this step can further comprise selecting a particular evaluation criteria from amongst the plurality of candidate evaluation criteria to use when evaluating 104 the image processing content.

It would be possible, of course, to store intermediary processing results and to support such evaluation subsequent to completing the overall image processing process 103. In many cases, however, it will likely be preferable to conduct such evaluations during the processing of the input image using the image processing process. So deployed, it may be possible to avoid useless time-consuming processing of an unacceptable image and to prompt a user (as disclosed below in more detail) to make a corrective action in a more timely manner.

This process 100 then provides 105 discrete image processing status information to a user as corresponds to the above-mentioned evaluation result(s). Such status information can take any of a wide variety of forms including visual, audible, and even tactile feedback. For many applications, a preferred approach will likely comprise providing visible status information such as, but not limited to, an image of an informational icon (examples of illustrative informational icons are presented below).

For some purposes it may be adequate to provide status information that corresponds on a one-to-one basis with a given corresponding state as relates to the status information. In other cases, however, it may be preferable to provide a plurality of status information candidates. When a plurality of candidates are available, the described process can preferably select a particular status information candidate as a function, at least in part, of the relative importance of the discrete image processing step as corresponds to the evaluation result and/or information regarding the relative experience of the user. For example, upon ascertaining that a given user is relatively inexperience with respect to the image capture process and/or the larger process being supported by the image capture process, it may be appropriate to provide more highly instructional status content. When, however, the user is more experienced, it may be sufficient to provide more simplified and summarized status content.

So configured, intermediary processing results of an image processing process comprised of discrete steps are analyzed to ascertain, for example, a degree to which the input image is, in fact, suitable to support useful subsequent processing. When not true, this process then provides for intermediary status information to be provided to the user. The user, in turn, can make use of this feedback to improve the circumstances that attend the image capture process to thereby improve the likelihood that successful image processing will result.

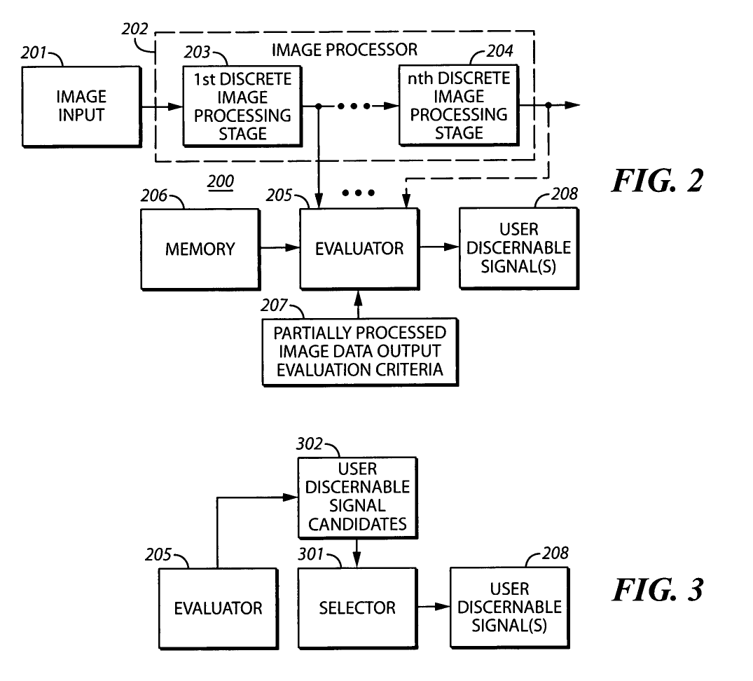

The described process 100 can be practiced with respect to a variety of implementing platforms. An illustrative image processing apparatus 200 will now be described with respect to FIG. 2. In a preferred approach, this image processing apparatus 200 comprises an image input 201 that receives a digital representation of a scene of interest from a source of choice. This image input 201 operably couples to an image processor 202 that itself comprises a plurality of discrete image process stages 203, 204. Those skilled in the art will recognize and understand that such an image processor 202 can comprise an array of dedicated hardware components and/or can comprise a partially or wholly programmable platform (or platforms).

In this illustrative embodiment, the output of one or more of these discrete image processing stages 203, 204 is operably coupled to an evaluator 205. This evaluator 205 also preferably operably couples to a memory 206 (that contains, for example, programming or other resources that permit and facilitate the functionality described above with respect to evaluation of the intermediary image processing results produced by the image processor 202) and that further has access to partially processed image data output evaluation criteria 207 (where the evaluation criteria preferably corresponds to a measure of processing acceptability as relates, at least in part, to a condition as regards the image being processed as described above). So configured, and pursuant to a preferred approach, this evaluator 205 serves to evaluate the image processing results as corresponds to a given one of the plurality of discrete image processing stages with respect to the at least one partially processed image data output evaluation criteria to provide a resultant evaluation result that corresponds to that given discrete image processing stage.

Depending upon the needs and/or limitations of a given application, a single evaluator 205 may be employed to conduct evaluations of a plurality of discrete image processing stages (using, for example, different corresponding evaluation criteria). Or, if desired, separate discrete evaluators can be employed with each evaluator being dedicated to a given corresponding image processing stage.

As per the teachings presented above, the evaluator 205 also operably couples to one or more user discernable signals 208. In a preferred approach, for example, the latter may comprise a graphic display such as, but not limited to, a liquid crystal display or the like. So configured, this display can respond to the evaluator 205 by presenting a particular selected user discernable signal as corresponds to and reflects a present evaluation result.

As mentioned earlier, a given evaluation result may potentially correlate to more than one candidate user discernable signal. For example, in some settings, a given evaluation result may relate to a processing step that has relatively small importance to a given overall image processing activity (that is, the processing step can be satisfactorily effected over a relatively wide range of conditions without impairing the overall intended functionality of the image processing activity. On the other hand, in other settings, that same evaluation result for that same processing step may be relatively important with respect to measuring or predicting whether the overall image processing activity will be successful. As another example already alluded to earlier, it is also possible that information is available to characterize the relative experience of a user with the image processing activity. The information provided to that user, in turn, can then be usefully varied to accord with the user's experience.

In such cases, and referring now to FIG. 3, a selector 301 may be operably coupled to the evaluator 205. The selector 301 can respond to the evaluator 205 to effect selection of a particular user discernable signal 208 from amongst a plurality of user discernable signal candidates 302 as are offered by the evaluator 205. Those skilled in the art will understand and appreciate that such selection functionality can be rendered in a discrete fashion (as suggested by the illustrative embodiment depicted in FIG. 3) or can be integrated with the capabilities of one or more other system elements such as, but not limited to, the evaluator 205 itself, the display, and so forth.

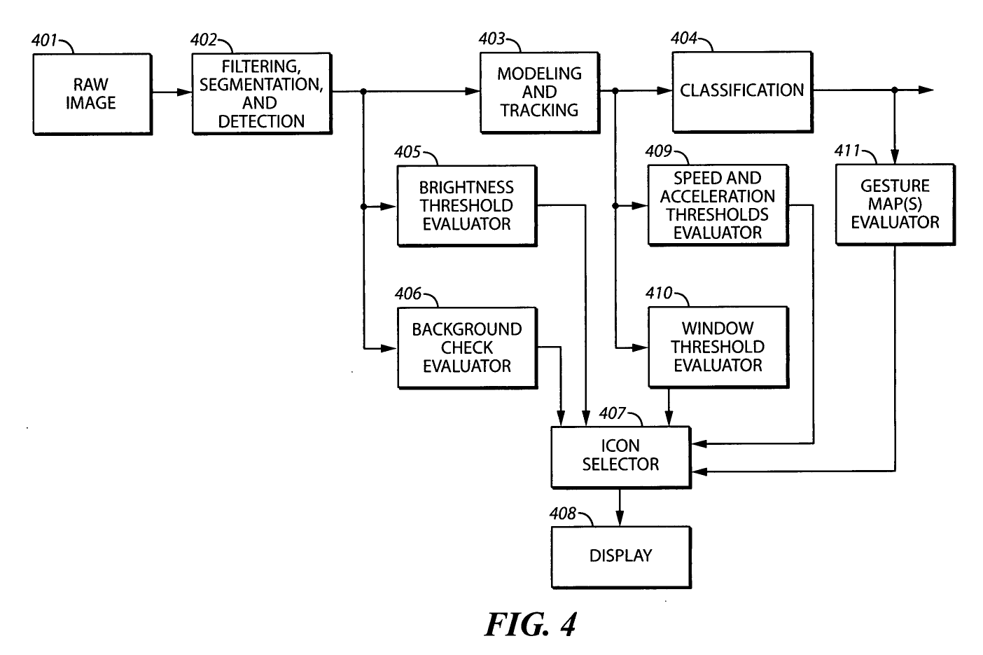

These teachings can be beneficially applied in a wide variety of settings. Referring now to FIG. 4, a more specific embodiment (directed, for illustration purposes, to a gesture recognition algorithm) will be described that may aid in illustrating these concepts. Pursuant to a given image processing activity, a raw image 401 is first processed using a filtering, segmentation, and detection stage 402. The resultant filtered, segmented, and detected image data is then processed using a modeling and tracking stage 403, with the output of the latter then being provided to a classification stage 404. Such stages and discrete processing activities are well understood in the art and will not be further described here for the sake of brevity.

The output of the filtering, segmentation, and detection stage 402 couples to a brightness threshold-based evaluator 405 and a background check evaluator 406. The former tests whether the resultant processed image data exhibits sufficient brightness to facilitate likely successful post-processing of the filtered, segmented, and detected image data. For example, the brightness threshold applied can be selected to reflect sensitivity to a minimal (or maximum) level of brightness that will serve as a prerequisite condition to likely successful image modeling, tracking, and/or classification. Similarly, the background check evaluator 406 can test whether the resultant processed image data appears to contain imagery wherein foreground and background components are sufficiently distinct from one another to permit likely successful post-processing of the filtered, segmented, and detected image data.

Both the brightness threshold evaluator 405 and the background check evaluator 406 couple, in this illustrative embodiment, to an icon selector 407. The icon selector 407, in turn, determines whether to present a given informational icon to a user via a corresponding display 408 and, if so, which informational icon to so present. For example, if the partially processed image data exhibits insufficient brightness as ascertained by the brightness threshold evaluator 405, a specific corresponding icon relating to this condition can be selected and displayed. In a preferred though optional approach, such an informational icon can be presented to a user prior to completion of the complete image processing activity.

In a somewhat similar manner, the output of the modeling and tracking stage 403 can operably couple to a speed and acceleration threshold evaluator 409 and a window threshold evaluator 410. The former can test, for example, for undue (or insufficient) motion in the processed image data while the latter can test for likely placement of an object of interest within a desired field of view in the image. As before, these evaluators 409 and 410 can also operably couple to the icon selector 407 to permit appropriate corresponding informational icons to be displayed when and as appropriate to reflect the resultant evaluation results.

And, again in a somewhat similar manner, the output of the classification stage 404 can further couple to a gesture map evaluator 411 where, for example, a specific object within the image (such as a user's hand) is tested with respect to expected or acceptable presentation and/or orientation. And again the output of the gesture map evaluator 411 can operably couple to the icon selector 407 to facilitate selection of a corresponding informational icon when and as appropriate.

So configured, partially processed image data is tested and evaluated for conditions that preferably relate to a likelihood of overall successful effectuation of an image processing activity. When and as conditions are identified that can negatively impact such likely success, corresponding information regarding such intermediary processing concerns can be provided to a user to prompt that user in a manner that will lead to a more likely successful result and experience.

The information provided to such a user can vary, both with respect to substantive content and with respect to the form of delivery. In many applications it may be beneficial to provide informational icons that express, in a simple and relatively intuitive fashion, the nature of the condition of concern.

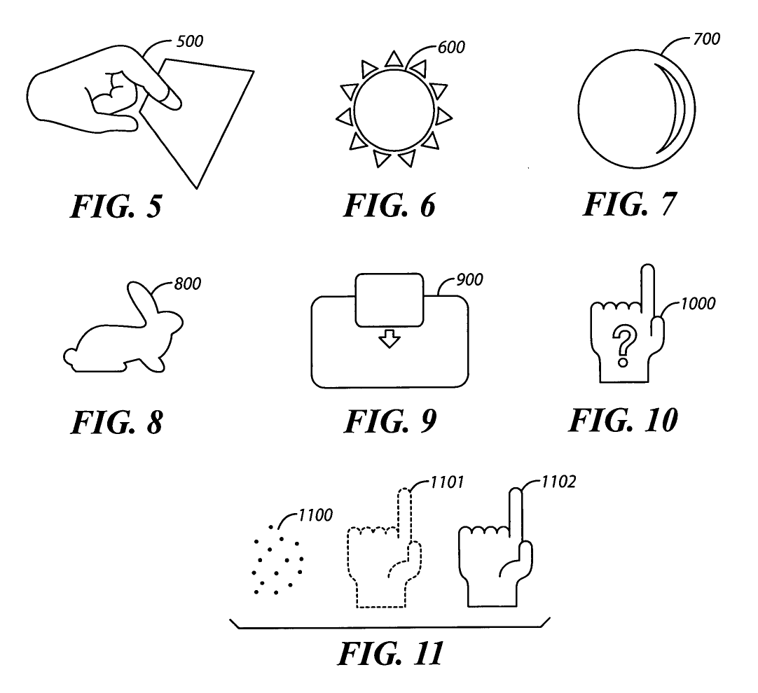

For example, the informational icon 500 depicted in FIG. 5 can serve to suggest a problem with respect to an existing field of depth condition. The informational icon 600 of FIG. 6 can serve to suggest a problem with respect to brightness. The informational icon 700 of FIG. 7 can serve to suggest a problem with respect to foreground/background confusion or interaction. The informational icon 800 of FIG. 8 can serve to suggest a problem with respect to motion or tracking. The informational icon 900 of FIG. 9 can serve to suggest a problem with respect to proper placement of the image with respect to a window or field of view. And the informational icon 1000 of FIG. 10 can serve to suggest a problem with respect to proper orientation, classification, or the like of an object to be recognized.

In the illustrative examples provided above, the informational icon comprises a static representation. If desired and/or as appropriate, a given informational icon can comprise a dynamic representation. For example, and referring now to FIG. 11, to encourage a user to place an object (such as their hand) within a particular desired depth field, a relatively amorphous display of dots 1100 can be provided to indicate that the object is considerably mis-positioned. As the user adjusts the position, and attains a closer but not yet optimal position, an intermediary display comprising a partially but not wholly distinct representation 1101 of a given object can be provided. Then, when the user achieves a satisfactory position, the icon can convert to and become a wholly distinct representation 1102 of the given object.

Those skilled in the art will recognize that the above-described informational icons are illustrative only and do not comprise an exhaustive listing of all useful possibilities. For example, color can be used (in a static and/or dynamic form) to convey status information to a user. Such color can comprise a general background of a display or some smaller portion thereof. Color may also be used as a part of an icon as is otherwise described above (for example, the color (or colors) as comprise a given icon may change to convey different conditions to the user). In effect, color itself can comprise a part of, or itself comprise, an informational icon for these purposes. It will also be understood that such visual indicators can be supplemented by, or replaced by, other kinds of user perceivable cues, including but not limited to auditory content, haptic content, and so forth.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, for the purposes of illustrating a given embodiment, the above description presents an evaluator (or evaluators) that use a partially processed image. That is, the evaluator makes use of the partially processed image output of a preceding processing stage. These same teachings, however, will be understood to be applicable in other settings as well. For example, a given evaluator may also receive and utilize unprocessed image information (i.e., the raw image information) and may use that unprocessed image information, alone or in conjunction with partially processed image information, to inform its evaluation processing. As another example, a given mid-process evaluator may receive partially processed image results from a plurality of discrete processing stages and then use those multiple images to facilitate its own mid-process evaluation.

We claim:

1. A method for use with an image processing process, which image processing process is comprised of a plurality of discrete image processing steps, the method comprising:
receiving an input image;
processing the input image using the image processing process;
evaluating image processing content as corresponds to one of the plurality of discrete image processing steps with respect to at least one evaluation criteria to provide an evaluation result that corresponds to that one of the plurality of discrete image processing steps;
providing discrete image processing status information to a user as corresponds to the evaluation result.

2. The method of claim 1 wherein the plurality of discrete image processing steps comprise at least one of:
an image filtering processing step;
an image segmentation processing step;
an image detection processing step;
an image tracking processing step;
an image modeling processing step;
an image classification processing step;
an image recognition processing step.

3. The method of claim 1 wherein providing discrete image processing status information to a user as corresponds to the evaluation result comprises selecting the discrete image processing status information from amongst a plurality of candidates as a function, at least in part, of at least one of:
relative importance of the discrete image processing step as corresponds to the evaluation result;
information regarding relative experience of the user.

4. The method of claim 1 wherein evaluating image processing content as corresponds to one of the plurality of discrete image processing steps further comprises evaluating image processing content as corresponds to a plurality of the plurality of discrete image processing steps.

5. The method of claim 1 wherein evaluating image processing content as corresponds to one of the plurality of discrete image processing steps further comprises evaluating the image processing content during the processing of the input image using the image processing process.

6. The method of claim 1 wherein evaluating image processing content as corresponds to one of the plurality of discrete image processing steps further comprises evaluating the image processing content subsequent to the processing of the input image using the image processing process.

7. The method of claim 1 wherein providing discrete image processing status information to a user as corresponds to the evaluation result further comprises providing visible discrete image processing status information.

8. The method of claim 7 wherein providing visible discrete image processing status information further comprises providing an image of an informational icon.

9. The method of claim 1 wherein evaluating image processing content as corresponds to one of the plurality of discrete image processing steps with respect to at least one evaluation criteria further comprises evaluating image processing content as corresponds to one of the plurality of discrete image processing steps with respect to at least one evaluation criteria, wherein the at least one evaluation criteria corresponds to a measure of processing acceptability as relates, at least in part, to a condition as regards the input image.

10. The method of claim 9 wherein the condition as regards the input image comprises at least one of:
image brightness;
image exposure;
image focus;
image white balance;
image frame rate;
a position of at least a portion of the image;
illumination of at least a portion of the image;
juxtapositioning of at least two portions of the image;
substantive image content;
movement of an element of the image;
temporal persistence of at least a portion of the image;
ambiguity with respect to substantive content of the image.

11. A memory having executable instructions stored therein, wherein the executable instructions, when executed, comprise:
evaluating image processing content as corresponds to one of a plurality of discrete image processing steps as comprises an image processing process with respect to at least one evaluation criteria to provide an evaluation result that corresponds to that one of the plurality of discrete image processing steps;
providing discrete image processing status information to a user as corresponds to the evaluation result.

12. The memory of claim 11 wherein evaluating image processing content further comprises evaluating image processing content as corresponds to a plurality of the plurality of discrete image processing steps.

13. The memory of claim 11 wherein evaluating image processing content further comprises evaluating the image processing content during processing of an input image using the image processing process.

14. The memory of claim 11 wherein evaluating image processing content further comprises evaluating the image processing content subsequent to processing of an input image using the image processing process.

15. The memory of claim 11 wherein providing discrete image processing status information to a user as corresponds to the evaluation result further comprises providing visible discrete image processing status information.

16. The memory of claim 11 wherein evaluating image processing content further comprises evaluating image processing content as corresponds to one of a plurality of discrete image processing steps with respect to at least one evaluation criteria, wherein the at least one evaluation criteria corresponds to a measure of processing acceptability as relates, at least in part, to a condition as regards an input image.

17. An image processing apparatus comprising:
an image input;
an image processor being operably coupled to the image input and being comprised of a plurality of discrete image processing stages, wherein at least some of the discrete image processing stages has a corresponding partially processed image data output;
at least one partially processed image data output evaluation criteria;
an evaluator having inputs operably coupled to the partially processed image data output of at least one of the discrete image processing stages and to the at least one partially processed image data output evaluation criteria and having a partially processed image data output evaluation output;
a user discernable signal that is responsive to the partially processed image data output evaluation output.

18. The image processing apparatus of claim 17 wherein the at least one partially processed image data output evaluation criteria corresponds to a measure of processing acceptability as relates, at least in part, to a condition as regards an image that is input to the image input.

19. The image processing apparatus of claim 17 wherein the evaluator further comprises means for evaluating image processing content as corresponds to one of the plurality of discrete image processing stages with respect to the at least one partially processed image data output evaluation criteria to provide an evaluation result that corresponds to that one of the plurality of discrete image processing stages.

20. The image processing apparatus of claim 17 and further comprising selection means that is responsive to the evaluator for selecting the user discernable signal as a function, at least in part, of at least one of:
relative importance of the discrete image processing stage as corresponds to evaluation of the partially processed image data output;
information regarding relative experience of a user of the image processing apparatus.
